(19) United States
(12) Patent Application Publication
(10) Pub. No.: US 2014/0092757 A1
(43) Pub. Date: Apr. 3, 2014

(54) Controlling Data Synchronization and Backup Services

(71) Applicant: FUTUREWEI TECHNOLOGIES, CO., Plano, TX (US)

(72) Inventors: Jun Xu, Cupertino, CA (US); Ronnie Tong, Fremont, CA (US); Venkatesh Chatanur, San Jose, CA (US)

(73) Assignee: FUTUREWEI TECHNOLOGIES, CO., Plano, TX (US)

(21) Appl. No.: 13/632,647

(22) Filed: Oct. 1, 2012

(51) Int. Cl. H04L 12/26

(52) U.S. Cl. 370/252

(57) ABSTRACT

A method implemented in a router, the method comprising measuring a load of normal traffic on a network link to generate a first measurement, initiating a backup service based on the first measurement, and transmitting backup data traffic associated with the backup service on the network link, wherein the normal traffic is not associated with the backup service, and wherein the backup data traffic has lower priority than the normal traffic.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

In some networks, data can be transferred and stored in backup systems, e.g., at data centers. The backup data is stored and subsequently retrieved or recovered in case of system failures. The backup data may belong to backup or synchronization services that require storing data in a remote location from a network central office or a customer. Examples of backup and synchronization services include video surveillance services, database services, file systems, and other types of non-real-time services. In the case of synchronization services, the data may be stored at two locations in the network, for example at a central office of the network and a local office between the network and the customer. The data stored at the two locations may be synchronized, e.g., periodically, to ensure that the data at the different locations match each other.

The data stored in the network backup systems is part of network traffic that is transported along the network, e.g., on one or more links. For example, the data is part of traffic that is transferred from a network core to an access or edge router, a gateway, or a customer edge to vice versa. The router or gateway may forward the data from the network branches that belong to backup and/or synchronization services (referred to herein as backup data) to one or more backup systems at one or more remote locations (e.g., data centers) to store the backup data. Generally, backup data traffic has lower priority than other traffic in the network (referred to herein as normal traffic), which includes real-time traffic and any other non-backup data traffic.

Present backup systems are configured to store data beginning at predetermined times. For example, a backup system is configured to begin a backup data process at a specified start time or only allow backup to take place between specified times on a daily basis. The backup system may include manual processes that require human intervention or operation, such as to create different backup files for different services and to set up policy for storing data on the files. The policy includes setting up different time frames for backing up different services. Storing backup or synchronization services at fixed time frames may not be suitable for handling traffic volume that varies over time or for handling multiple different data types and services. Multiple manual settings may be needed to handle different services and different network conditions, which may be less efficient and practical as more services and network conditions exist. The data center movement and enterprise globalization make it more difficult to define a fixed time frame when networks are less busy, i.e., carry less traffic. When normal traffic, such as real-time data, is exchanged during a fixed time frame for backup, the normal traffic and the backup data traffic can suffer significant delays and/or losses since both types of data share and compete for link bandwidth and network resources. Thus, there is a need to improve backup data procedures.

### SUMMARY

In one embodiment, the disclosure includes a method implemented in a router, the method comprising measuring a load of normal traffic on a network link to generate a first measurement, initiating a backup service based on the first measurement, and transmitting backup data traffic associated with the backup service on the network link, wherein the normal traffic is not associated with the backup service, and wherein the backup data traffic has lower priority than the normal traffic.

In another embodiment, the disclosure includes a router for handling a backup service comprising a counter configured to measure a load of normal traffic, wherein the normal traffic is traffic that is not associated with the backup service on a network link, and a processor coupled to the counter and configured to receive a measurement of the load from the counter, and initiate the backup service when the measurement is determined to be low.

In yet another embodiment, the disclosure includes a router comprising a service card configured to communicate with a backup service on a first network link, and a processor configured to instruct the service card to begin the backup service based on a measurement of normal traffic on a second network link.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic diagram of an embodiment of a network backup system.

FIG. 2 is a flowchart of an embodiment of an adaptive backup and synchronization method.

FIG. 3 is a schematic diagram of an embodiment of a router.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein are systems, methods, and apparatuses for providing adaptive data backup and synchronization services in a network. The backup of data may be started and stopped in the network based on the measured traffic load on one or more links to adapt to traffic load. The adaptive data backup and synchronization services may be started or stopped by a router or network node, such as an access or edge router, a gateway, or a customer edge, that may be positioned between two networks or domains, such as a local area network (LAN) and a wide area network (WAN). The router may also be coupled to a backup system for storing some of the network traffic. The backup system may comprise one or more storage devices, for example that are located in a local office of the router. The local office may be coupled to a data center via a WAN link. The router may identify different traffic on the link, e.g., based on service identifiers (IDs), to distinguish between normal traffic and backup data traffic. The router may comprise or be coupled to one or more service cards or appliances that control backup and synchronization services, and the service cards or appliances may be instructed to initiate their services when a low normal traffic load is detected on the link or suspend or disable the backup services otherwise.

Triggering the backup and synchronization services based on the normal traffic load on the link may minimize the data backup latency and maximize the link usage. Since the adaptive data backup and synchronization services are based on normal traffic load, the services may not use or need fixed time frames, which may avoid the inefficiencies of network backup systems that use fixed time frames. The backup and synchronization services may also be based on a policy that sets a low normal traffic threshold for triggering the services. Further, different data backup and synchronization services may be assigned different priority, where the services may be triggered in a sequence based on the order of their priority. Hence, contention by multiple services for link resources may be avoided during backup time.

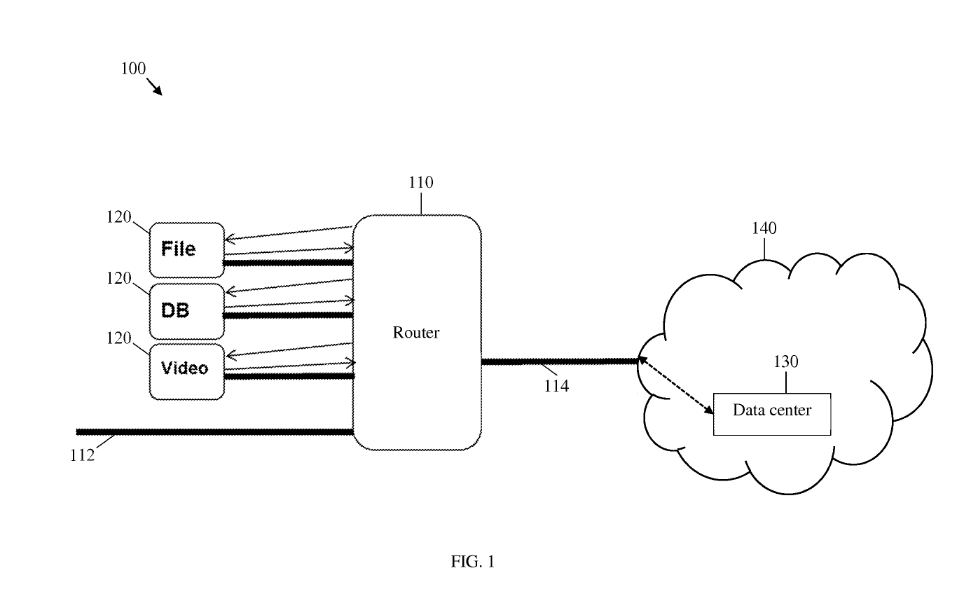

FIG. 1 illustrates an embodiment of a network backup system 100 that may be used to provide adaptive backup or synchronization service in a network. The network backup system 100 may comprise a router 110 which may be coupled via a first link 112 to a network or domain (not shown), such as a LAN, and via a second link 114 to a data center 130, which may reside in a WAN 140. For instance, the first link 112 may be a LAN link, and the second link 114 may be a WAN link. The router 110 may be coupled to a LAN via a first link 112 and to a WAN 140 via the second link 114. The router 110 may also be coupled to one or more backup data systems 120 via links as shown. The links discussed herein may be any type of optical or electrical network link for transporting data signals. In FIG. 1, one backup system is illustrated as a file backup service, one backup system is illustrated as a database (DB) backup service, and one backup system is illustrated as a video backup service. These services are used for illustrative purposes and other backup services are possible. In other embodiments, the network backup system 100 may comprise a plurality of routers 110 that may be configured similarly and coupled to one or more LANs, WANs, and the backup data systems 120. The WAN may be an Internet Protocol (IP) network or any other type of WAN.

The router 110 may be an edge node of the network, such as an edge or access router, a gateway, or a customer edge device that may be configured to forward traffic between a first link 112 (e.g., a LAN link) and a second link 114 (e.g., a WAN link). The backup data systems 120 may comprise storage units or devices that store data forwarded from the router 110, send stored data to the router 110, or both. The backup data systems 120 may be located in one or more remote locations from a network core (e.g., a WAN), such as in one or more data centers or at a local office with the router 110. The router 110 may forward data from traffic received on a second link 114 (e.g., a WAN link) to the backup data systems 120, and send stored data from the backup data systems 120 on the second link 114 to a data center 130 for backup. The data center 130 may reside in a WAN.

The router 110 may comprise one or more service appliances and/or service cards that may control corresponding backup and synchronization services. The services may generate relatively high volume and low priority traffic, which may be exchanged via the second link 114 and/or the first link 112 (e.g., LAN links). The backup data may have lower priority in comparison to the normal traffic (e.g., real-time or web based traffic). Examples of the lower priority data include backup data for video surveillance services, database services, file systems, and other types of services where data is stored remotely and subsequently retrieved. The router 110 may receive lower priority data from WAN 140 on t second link 114 and forward the data to the backup data systems 120. To retrieve the backup data, the router 110 may send the stored data from the backup data systems 120 on the second link 114 to the WAN 140 when the data is needed, in the case of data loss, or in the case of network failure. Alternatively, the stored data may be sent back to the network to synchronize the data that may be stored in a local office (e.g., associated with a LAN) with data stored at data center 130.

The router 110 may monitor and measure the traffic load on the second link 114 (the WAN link), e.g., in terms of load, which may be measured in terms of bandwidth and/or data rate. The measured traffic may comprise traffic sent from the WAN 140 to the router 110, traffic sent from the router 110 to the WAN 140, or both. The router 110 may measure the load of different types, including different backup data traffic and other normal traffic (non-backup traffic). The router 110 may distinguish between the backup data traffic and the normal traffic based on service IDs (e.g., quality of service (QoS) IDs), application IDs, or both. Such service and application IDs may be used to distinguish traffic of different services and applications and may be embedded in the packets of the corresponding traffic.

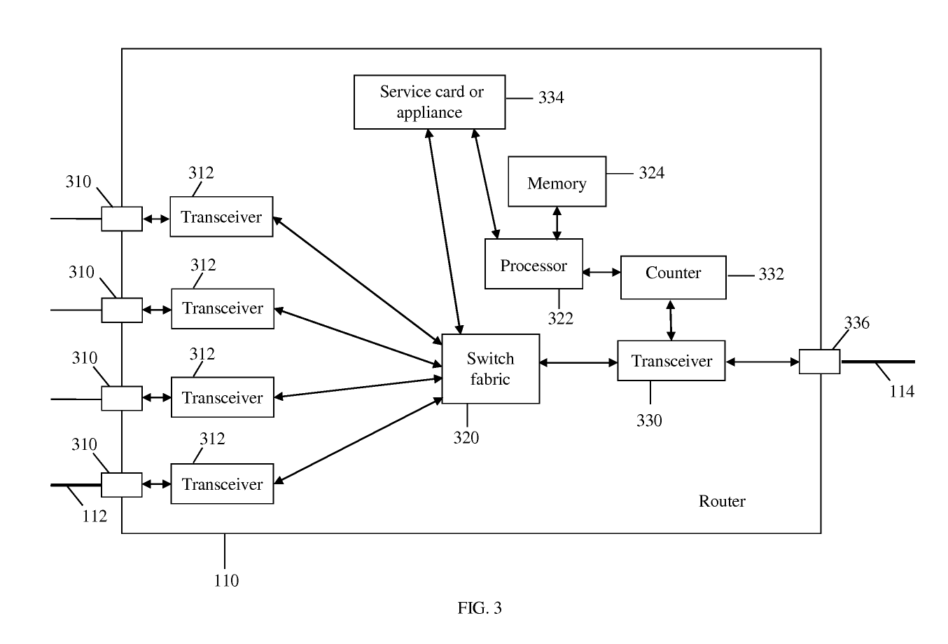

When the traffic load on the second link 114 is determined to be light or low, a service card or appliance (not shown), which may be coupled to or part of router 110, may be instructed by a policy element in the router 110 to initiate or trigger the backup or synchronization service, and hence router 110 may start to receive or send backup data on the link 114. The policy element may be a processor in the router 110 configured to implement policy rules as discussed further with respect to FIG. 3 below. The monitored traffic load on the second link 114 may be determined to be light or low based on a determined policy or service level agreement (SLA). For instance, the traffic may be determined to be low if the normal traffic, i.e., the non-backup traffic, is below a determined threshold (e.g., in terms of bandwidth or data rate) according to policy or SLA. The threshold may be a determined value (bandwidth or data rate) or a percentage of the total bandwidth or data rate of the second link 112, for example about 10 percent of the total link capacity. Alternatively, according to policy or SLA, the traffic may be determined to be low if the normal traffic on the second link 114 is idle.

If the traffic load on the second link 114 is not deemed to be low, the service card or appliance may be instructed by the policy element in the router 110 to suspend or disable the backup or synchronization service. In another scenario, the service card or appliance may be instructed to suspend or disable the backup or synchronization service when the normal traffic load on the second link 114 is above a determined threshold or when the second link 114 is utilized more than a determined percentage, according to policy or SLA. The service card or appliance may be instructed to initiate the backup or synchronization service when the normal traffic load on the second link 114 is below a determined threshold or is idle on the second link 114. To suspend the backup or synchronization service, the service card or appliance may be instructed to signal the appropriate backup data system 120 to stop forwarding the backup traffic between the backup data system 120 and the router 110. The backup or synchronization service may later be restarted where it left off without packet loss. Alternatively, the backup or synchronization service may be disabled by dropping the backup data packets at the router 110.

The backup or synchronization service may be suspended or disabled by the router 110 based on measurement of the traffic on a second link 114, as described above. The router 110 may measure the ingress and/or egress bandwidth for the traffic on the second link 114 (e.g., the normal traffic) to determine suspending or disabling the service, as described above. Thus, the backup or synchronization service may be suspended locally at the router 110 between the first link 112 and the second link 114. In another embodiment, the backup or synchronization service may be suspended or disabled remotely, e.g., from the first link 112 to the second link 114 or from the second link 114 to the first link 112.

Further, different types of backup traffic may be assigned different priority. As such, the router 110 may initiate the different backup or synchronization services in the order of their assigned priority, where the backup or synchronization service with the highest priority may be initiated first followed by the backup or synchronization service with lower priority. For example, a file backup service may be assigned a first priority (highest), a database service may be assigned a second priority, and a video surveillance service may be assigned a third priority (lowest). Accordingly, the file backup service may be initiated first, followed by the database service, and then the video surveillance service. A higher priority service may be allowed to finish its backup or synchronization first before a lower priority service is initiated. This may avoid a situation of having multiple backup/synchronization services attempting to backup data at about the same time, which may cause undesired delays, losses, competition for resources, or combinations thereof. The router 110 may also disable the different backup or synchronization services in the order of their assigned priority, e.g. starting first with the service that has lowest priority. For example, the video surveillance service that has lowest priority may be disabled first, followed by the database service, and then the file backup service.

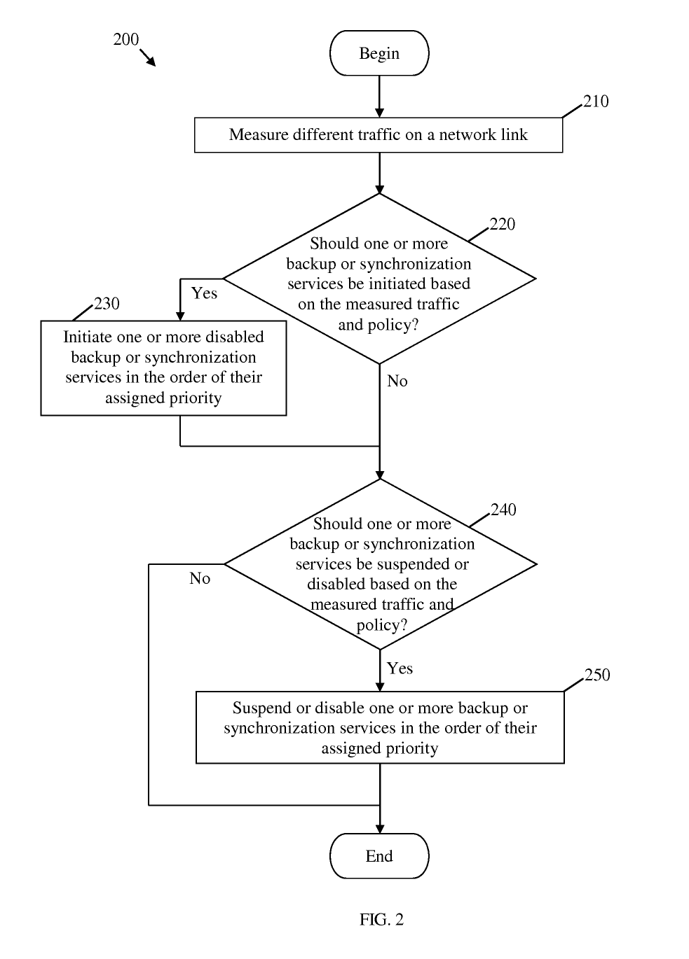

FIG. 2 illustrates an embodiment of an adaptive backup and synchronization method 200, which may be implemented to provide adaptive backup or synchronization service based on the measured traffic load. For instance, the adaptive backup and synchronization method 200 may be implemented by a router in a network backup system, such as the router 110 in the network backup system 100. The method 200 may begin at block or step 210, where different traffic on a network link may be measured to generate one or more measurements. For example, the network link may be a WAN link, such as link 114, that connects an access or edge router, a gateway, or a customer edge, such as router 110, to a WAN. The different traffic may comprise different types of normal traffic and backup traffic. The packets of each type may be identified by a corresponding service or application ID. If backup services have not started or have been suspended, there may be no backup traffic and measuring different traffic may comprise measuring normal traffic.

At decision block 220, the method 200 may determine whether one or more backup or synchronization services should be initiated based on the measured traffic and a policy. For instance, based on policy, the one or more services may be initiated if the measured normal traffic, or one or more measurements of normal traffic load, is below a threshold, the WAN link is underutilized, or both. If the condition in block 220 is true, then the method 200 may proceed to block 230. Otherwise the method 200 may proceed to block 240. At block or step 230, the one or more disabled backup or synchronization services may be initiated in the order of their assigned priority.

At decision block 240, the method 200 may determine whether one or more backup or synchronization services should be suspended or disabled based on the measured traffic and policy. For instance, based on policy, the one or more services may be suspended or disabled if the measured normal traffic is not below a threshold, the WAN link is not underutilized, or both. If the condition in block 240 is true, then the method 200 may proceed to block 250. Otherwise the method 200 may end. At block or step 250, the one or more backup or synchronization services may be suspended or disabled in the order of their assigned priority. The method 200 may then end. In some embodiments, the method 200 may be implemented continuously in a loop, where the method 200 may return (after blocks or steps 240 and 250) to block 210 instead of ending.

FIG. 3 is a schematic diagram of an embodiment of the router 110. The router 110 may comprise one or more ports 310 and 336 coupled to transceivers 312 and 330, respectively. The transceivers 312 and 330 transmit data to and receive data from other devices. The transceivers 312 may transmit data to or receive data from one of the backup data systems 120 or a LAN via the link 112. The transceiver 330 may transmit data to or receive data from a WAN, such as WAN 140, via the WAN link 114. The transceiver 312 and 330 may take the form of modems, modem banks, Ethernet cards, universal serial bus (USB) interface cards, serial interfaces, token ring cards, fiber distributed data interface (FDDI) cards, or any other available technology to allow router 110 to communicate with other network devices. The router 110 may further comprise switch fabric 320 for routing packets to or from one line, such as WAN link 114, to another line.

The router 110 further comprises a counter 332, a processor 322, and a memory 324 configured as shown. The counter 332 may be implemented as an interface counter or a feature counter. As is understood in the art, a router, such as router 110, may comprise an interface counter or a feature counter coupled a transceiver, such as transceiver 330, wherein the interface counter or feature counter is configured to measure traffic on a link, such as WLAN link 114. The counter 332 may measure traffic of a specific traffic class, such as normal traffic, as opposed to backup traffic.

The counter 332 may be coupled to a processor 322, which may be referred to as a policy element, and the processor 322 implements the policy or rules on whether a backup service should be initiated. Although illustrated as a single processor, the processor 322 be implemented as one or more CPU chips, cores (e.g., a multi-core processor), field-programmable gate arrays (FPGAs), application specific integrated circuits (ASICs), and/or digital signal processors (DSPs). Although illustrated as a single memory, the memory 324 may include read only memory (ROM), random access memory (RAM), or secondary storage, which is typically comprised of one or more disk drives or erasable programmable ROM (EPROM) and is used for non-volatile storage of data. Secondary storage may be used to store programs that are loaded into RAM when such programs are selected for execution. It is understood that by programming and/or loading executable instructions onto the router 110, at least one of the processor 322 or the memory 324 are changed, transforming the router 110 in part into a particular machine or apparatus, e.g. having the novel functionality taught by the present disclosure.

The processor 322 may be coupled to a service card or appliance 334. The service card or appliance 334 may be a service card or an appliance, but not both—the term service card or appliance is used to capture both possibilities. Although the service card or appliance 334 is shown as part of router 110 for the purpose of illustration, an appliance may alternatively not be a part of the router, whereas a service card may be typically part of the router. The processor 322 may be coupled to the service card or appliance 334 regardless of whether the service card or appliance is part of or is not part of the router 110. The processor may communication with the service card or appliance via inter-process communication (IPC)/transmission control protocol (TCP).

If a backup service should be initiated (as determined by the processor 322), the processor 322 communicates with a service card or appliance 334 to instruct the service card or appliance 334 to begin backup services for one of the services. The message may, for example, be transmitted using IPC/TCP. The service card or appliance 334 may instruct the selected service and corresponding traffic, via the switch fabric 320 or LAN interface 310, to begin backup or synchronization service. The service card or appliance 334 could be one of or part of one of the backup devices 120 if the service is part of functions of the backup device. Otherwise, the service card or appliance 334 may send a message to a backup device, such as one of the backup devices 120, to tell the backup device to begin the backup or synchronization service. The service card or appliance 334 may also instruct the instructed service to suspend or disable backup, e.g., if the measured traffic is sufficiently high. Either the processor 322 or service card or appliance 334 may be said to initiate the backup service, although the processor 322 is the element that implement the decision-making logic. In this manner, the router 110 may implement or support the schemes described above for providing adaptive data backup or synchronization service, including the method 200.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. A method implemented in a router, the method comprising:
measuring a load of normal traffic on a network link to generate a first measurement;
initiating a backup service based on the first measurement; and
transmitting backup data traffic associated with the backup service on the network link, wherein the normal traffic is not associated with the backup service, and wherein the backup data traffic has lower priority than the normal traffic.

2. The method of claim 1, wherein the normal traffic and the backup traffic are identified by different corresponding service or application identifiers (IDs).

3. The method of claim 1, wherein the backup service is initiated if the first measurement is below a threshold.

4. The method of claim 1, further comprising:
measuring the load of normal traffic on the network link to generate a second measurement; and
suspending the backup service if the second measurement is above the threshold.

5. The method of claim 1, wherein the backup service is initiated if the first measurement indicates the network link is idle.

6. The method of claim 1 further comprising:
assigning different priorities to a plurality of backup services; and
initiating the plurality of backup services in the order of their assigned priority from highest priority to lowest priority.

7. The method of claim 6, further comprising:
measuring the load of normal traffic on the network link to generate a second measurement; and
suspending a backup service if the second measurement is above the threshold.
wherein the backup service that is suspended is selected from among the plurality of backup services as having the lowest priority.

8. The method of claim 1, further comprising measuring the load at different times to generate a plurality of load measurements, wherein the backup service is initiated and suspending at different times according to the plurality of load measurements.

9. The method of claim 1, wherein the backup service comprises a synchronization service that stores data at two network locations and synchronizes the data at the two network locations to match the data.

10. A router for handling a backup service comprising:
a counter configured to measure a load of normal traffic, wherein the normal traffic is traffic that is not associated with the backup service on a network link; and
a processor coupled to the counter and configured to:
receive a measurement of the load from the counter; and
initiate the backup service when the measurement is determined to be low.

11. The router of claim 10, wherein the measurement is determined to be low when the load is less than about 10 percent of the total capacity of the network link.

12. The router of claim 10, wherein the processor is further configured to disable the backup service when the load of the normal traffic stops being low.

13. The router of claim 12, wherein disabling the backup service comprises stopping the transmission of backup data traffic associated with the backup service on the network link.

14. The router of claim 12, wherein disabling the backup service comprises dropping at least one packet associated with the backup service on the network link.

15. A router comprising:
a service card configured to communicate with a backup service on a first network link; and
a processor configured to instruct the service card to begin the backup service based on a measurement of normal traffic on a second network link.

16. The router of claim 15, wherein the processor is further configured to instruct the service card to disable the backup service and stop exchanging the backup data traffic on the network link based on a second measurement of normal traffic on the second network link.

17. The router of claim 15, wherein the processor is further configured to instruct the service card to disable the backup service and drop the backup data traffic on the network link based on a second measurement of normal traffic on the second network link.

18. The router of claim 15, wherein the second network link is a wide area network (WAN) link coupled to the router that transports the backup data traffic between the router and a WAN.

19. The router of claim 18, wherein the first network link is a local area network (LAN) link coupled to the router.

20. The router of claim 15, wherein the backup service exchanges the backup data traffic with one or more backup data systems that are coupled to the router.
